(19) United States
(12) Patent Application Publication
(10) Pub. No.: US 2010/0122783 A1
(43) Pub. Date: May 20, 2010

(54) Window Covering For Energy Conservation

(76) Inventors: Angela Harris, Durham, NC (US); Rosa Brown, Upper Marlboro, MD (US)

Correspondence Address: MEGAN LYMAN, 1816 SILVER MIST CT., RALEIGH, NC, 27613, US

(21) Appl. No.: 12/621,849

(22) Filed: Nov. 19, 2009

Related U.S. Application Data
(60) Provisional application No. 61/116,554, filed on Nov. 20, 2008.

(51) Int. Cl. E06B 9/24

(52) U.S. Cl. 160/405

(57) ABSTRACT

The present invention is an environmentally conscious window covering that will reduce the demand for electricity and appeal to the market for green building products used in construction and remodeling projects. The present invention is generally comprised of three layers, an outer eco-friendly (or “green) fabric layer that faces the interior of a building, an inner layer that may comprise polyethylene (PET) film layer that is aluminized and reflects 99% of ultraviolet rays, and an inner sheer layer that faces the window. The three layers are not adhered by synthetic or toxic adhesives. The present invention may also be equipped with an opening in the outer layer in the upper portion that can receive a rod for installation in the window space.

This application claims the benefit of U.S. Provisional Application No. 61/116,554 filed Nov. 20, 2008.

### BACKGROUND

1. Field of Invention

This invention relates to window coverings, more specifically, a multi-layered window covering constructed with ecologically-friendly (“eco-friendly”) fabrics and dyes and polyethylene coated reflective material that protects the interior of the building from ultraviolet ray deterioration, excess heating from the outside, and excess cooling when applicable. The present invention consists of at least three layers, an outer decorative layer visible when in the interior of a room, a middle reflective layer, and an inner sheer layer that is closest to the window.

2. Brief Description of the Prior Art

Rising levels of energy consumption is one of the most pressing problems of our time. According to the Energy Information Administration, purchased electricity by both residential and commercial buildings will continue to be a dominant source of carbon dioxide emissions growth through 2030. Recent studies contend that energy efficiency alone can reduce U.S. electricity use by 30 percent and eliminate the need for more than 60 percent of the country's coal-fired generation.

One of the main sources of energy loss in a building is through its windows. Heat is introduced in the summer as light passes through and heat becomes trapped; and heat is lost in the winter as the insulation properties of the window are not as efficient as the rest of the building structure. To combat this very common problem, many methods of insulation are used such as shutters, blinds, heavy draperies, quilted shades, window films, energy efficient windows, and the like. Each of these potential solutions can pose aesthetic problems for the owner, and/or do not reduce energy loss to an acceptable level. For instance, shutters, and window films are not “soft” in appearance, and are aesthetically unappealing to most consumers. While conventional draperies add some insulation to the window, there is much room for improvement in terms of energy efficiency. Moreover, conventional draperies, and many other window coverings do not take into consideration ecologically minded consumers.

Many consumers would like to increase the energy efficiency of their building while remaining ecologically conscious. The use of “green” materials in the fabrication and decoration of buildings is becoming more prevalent and attractive to many consumers. A 2007 University of Wisconsin Report states that most major manufacturers of window coverings (such as Spring Windows, Levolor-Kirsch, Rockland Industries, Temptrol Radiant Curtains, and Hanes Fabrics) do not offer “green” options. In the field of window coverings though some of the fabrics that are used are “green,” many are treated chemically to enhance their fire retardant ability or blackout ability.

Moreover, “blackout fabrics” impede light, but also absorb more heat, offering inadequate ventilation and adding to the energy problem. Those fabrics are not appealing to the ecologically minded consumer.

Although some companies do provide some eco-friendly window coverings (e.g., Hunter Douglas), they are relatively expensive, require custom installation, and their eco-friendly fabrics are not widely used (2007 University of Wisconsin Report).

Previous attempts to combine fabrics with metallurgical layers or properties do not integrate ecologically friendly fabrics and methods of manufacture. Some window coverings use foils or PVC to accomplish light reflection. These compounds are less flame retardant than polyethylene. In addition, these multi-layered window covering systems contain adhesives that can emit toxins that are not naturally derived.

The studies discussed above underscore a tremendous near-term opportunity to immediately reduce electricity use and greenhouse gases. Moreover, consumers are financially incentivized by the government or corporations to integrate ecological and sustainable materials into their construction and/or remodeling projects. Presently, no window coverings address the concerns of ecologically conscious consumers while increasing energy efficiency, conforming to or exceeding fire retardant standards, and virtually eliminating ultraviolet radiation into a building.

### SUMMARY OF THE INVENTION

The present invention offers an environmentally conscious window covering that will reduce the demand for electricity and appeal to the market for green building products used in construction and remodeling projects. Specifically, the present invention is both novel and more compelling than competing, currently available alternatives due to its environmental sustainability. The characteristics that make the present invention as such are: 1) a base material that is completely sustainable, 2) highly attractive fenestration properties, and 3) a reduction in electricity consumption. While the present invention would likely be used most frequently in a window, it is equally applicable to cover other openings where the user would like to limit solar irradiation.

The present invention is comprised of three layers, an outer eco-friendly (or “green) fabric layer that faces the interior of a building, an inner polyethylene (PET) film layer that is aluminized and reflects 99% of ultraviolet rays, and an inner sheer layer that faces the window. The three layers are not adhered by synthetic or toxic adhesives. The present invention may also be equipped with an opening in the outer layer in the upper portion that can receive a rod for installation in the window space.

It is an object of the present invention to provide a window covering for energy conservation that is constructed with eco-friendly fabrics and dyes that protects building interiors while providing energy conservation and aesthetic appeal.

It is another object of the present invention to provide a window covering for energy conservation that reduces costs of cooling a building as a result of undesired solar heat gain by reflecting ultraviolet and other light.

It is yet another object of the present invention to provide a window covering for energy conservation that substantially prevents the penetration of ultraviolet light and accumulation of heat into the interior of a building during warmer months and limits heat loss during cooler months.

It is an object of the present invention to provide a window covering for energy conservation, which protects the interior of a building from sun damage.

It is another object of the present invention to provide a window covering for energy conservation that is inexpensive to manufacture, simple to install, and easy to maintain.

It is yet another object of the present invention to provide a window covering for energy conservation, which is easy for consumers to install without professional assistance.

Another object of the present invention to provide a window covering for energy conservation that is cost efficient and affordable.

It is another object of the present invention to provide a window covering for energy conservation that offers an aesthetically appealing appearance.

It is yet another object of the present invention to provide a window covering for energy conservation that uses eco-friendly or green fabrics and dyes.

It is yet another object of the present invention to provide a window covering for energy conservation that uses environmentally friendly materials and methods of manufacture.

It is another object of the present invention to provide a window covering for energy conservation that is lightweight.

Another object of the present invention is to provide a window covering for energy conservation that contains multiple layers, which are not connected by synthetic or toxic adhesives.

Still other aspects of the present invention will become apparent to those skilled in the art from the following description of a preferred embodiment, which is by way of illustration, one of the best modes contemplated for carrying out the invention. As will be realized, the invention is capable of other different and obvious aspects, all without departing from the invention. Accordingly, the descriptions are illustrative in nature and not restrictive.

### DESCRIPTION OF THE DRAWINGS

The foregoing aspects and many of the accompanying advantages of this invention will become more readily appreciated as the same becomes understood by reference to the following detailed description, when taken in conjunction with the accompanying drawings, wherein:

FIG. 1 is a front view of the present invention showing the outer layer and rod pocket, according to one preferred embodiment of the present invention.

FIG. 2 is a side view of the present invention, illustrating the relationship between the window covering and the window, and illustrating the present invention's light reflective properties, according to one embodiment of the present invention. The rod that is affixed to the wall and goes through the rod pocket is also shown.

FIG. 3 is a cross sectional view of the present view, depicting the three layers and optional opening to accommodate an installation rod, as in one preferred embodiment of the invention.

### DETAILED DESCRIPTION

A invention described in detail herein generally relates to a window covering for energy conservation.

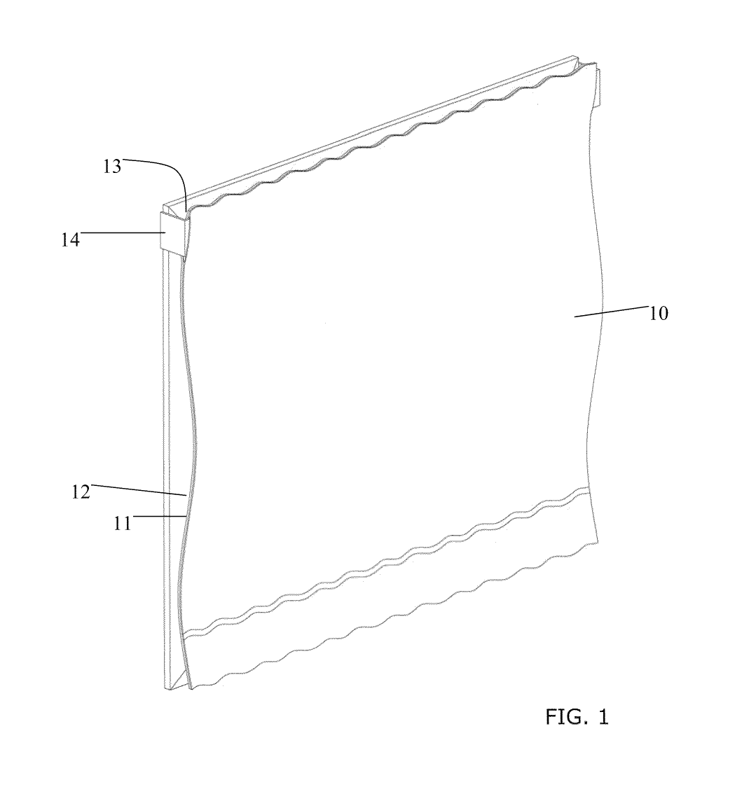

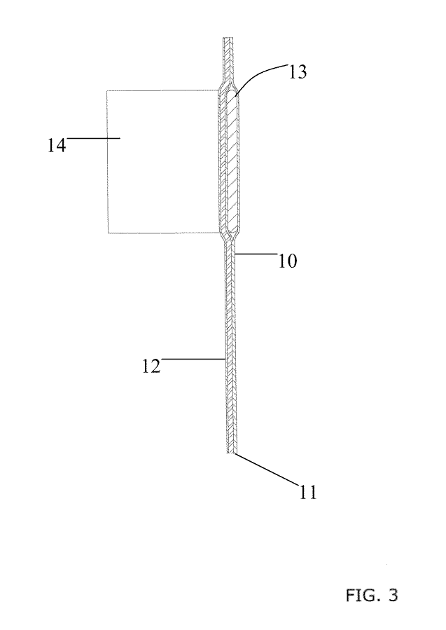

FIG. 1 illustrates a front view of the present invention, hanging from a window. The outer layer 10 of the present invention is visible from the interior of the building. FIG. 3 is a cross-sectional view of the present invention, illustrating the three layers of the window hanging, as in the preferred embodiment. The three layers are an outer layer 10 layer of eco-friendly (or green) fabric, the middle layer 11 is fabricated of metalized polyethylene (PET), and the inner layer 12 is made of a sheer fabric. Each layer of the present invention will be described in turn. Additionally, the term “eco-friendly” is synonymous with the term “green” for the purposes of describing the outer layer 10 of the present invention.

The eco-friendly fabrics that are used in the outer layer 10 of the present invention are predominantly “green”, meaning they are produced by nature and are grown in environments that minimize the use of harmful pesticides. Because the fabric is “green”, the carbon footprint of these fabrics will be substantially less when compared to synthetic fabrics. Synthetic fabrics will often require more energy to produce per ton of fiber than green fabrics. Natural fibers that comprise “green” fabrics include wool, hemp, jute, bamboo, alpaca, silk, and organic cotton. Additionally, green fabrics utilize the natural colors of the fabric, eliminating the need for dyes and other chemicals. For the purposes of the present invention, however, green fabrics may be dyed by ecologically friendly means with ecologically friendly dyes to achieve a pleasing aesthetic appearance to the outer layer 10. In terms of flame resistance, natural fibers also tend to be safer and less flammable than synthetic ones.

According to the American Chemistry Council, environmentally friendly, or “green” products leave a lighter footprint on the environment through conservation of resources, while at the same time balancing energy-efficient, cost-effective, low-maintenance products for end user needs. It is contemplated that green fabrics naturally have higher insulation properties, higher fire retardant properties, and are non-corrosive to the middle layer 11 of the present invention.

As stated, the outer layer 10 is comprised of a “green” fabric. In one preferred embodiment, the outer layer 10 has a base material of hemp fabric that is 55% hemp and 45% cotton. Hemp is naturally resistant to mold (i.e., antibacterial) and repels ultraviolet light. Hemp is also a breathable fabric that remains cool in warmer temperatures and is naturally warm in cooler temperatures. These characteristics add to the ability of the present invention to reduce visible transmittance and lower solar heat gain, which are key metrics established by the National Fenestration Rating Council when rating the energy performance of fenestration products.

Environmentally, hemp has excellent properties as a crop, making it an excellent choice for the outer layer 10 where the consumer is ecologically conscious. Hemp grows quickly, producing more fiber yield per acre than any other source. Hemp can produce 250% more fiber than cotton, and 600% more fiber than flax using the same amount of land. The amount of land needed for obtaining equal yields of fiber place hemp at an advantage over other fibers. Hemp also grows well in the United States, reducing the need for imports and long transports.

Hemp leaves the soil in excellent condition for any succeeding crop, especially when weeds may otherwise be troublesome. Where the ground permits, hemp's strong roots descend for three feet or more. The roots anchor and protect the soil from runoff, building and preserving topsoil and subsoil structures similar to those of forests. Moreover, hemp does not exhaust the soil. Hemp plants shed their leaves all through the growing season, adding rich organic matter to the topsoil and helping it retain moisture. Thus, the preferred embodiment of the invention has an outer layer 10 that uses a fabric comprised, in part, of hemp. Other natural or green fibers may comprise the outer layer 10 either in whole, or in combination with other natural or green fibers, as is apparent to those skilled in the art. The outer layer 10 in addition to being green, is also aesthetically pleasing to the consumer.

The middle layer 11 of the present invention is comprised of a polyethylene (PET) film that is metalized. In one preferred embodiment, the middle layer 11 is a PET film that is metalized with aluminum. Other suitable metals are known to those skilled in the art and their use does not depart from the scope of the present invention. The metalized portion of the middle layer 11 faces the window, while the non-metalized portion faces the interior of the building. The middle layer is comprised of ½ mil to 1 mil (or 0.0005 of an inch to 0.001 of an inch) metalized PET film with 2.0 to 2.2 optical density—reflects 99% of ultraviolet light (i.e., allows less than 1% of light transmission), as in the preferred embodiment of the invention. Other polymers than polyethylene, such as PVC, may be used in the middle layer 11 without departing from the scope of the invention.

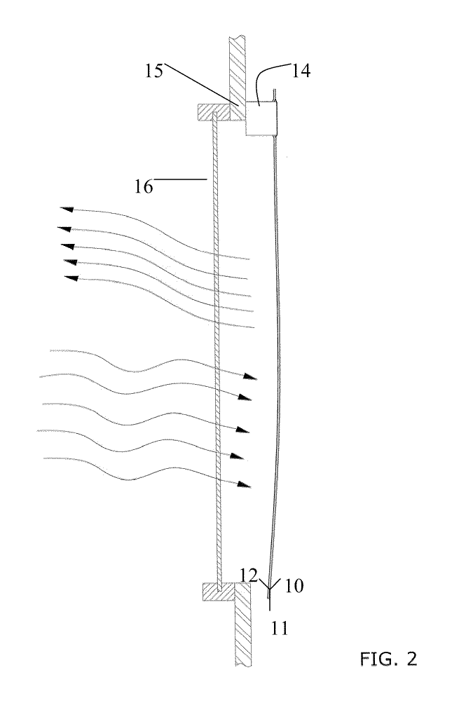

The inner layer 12 is a sheer fabric, such that light may reach the middle layer 11 to be reflected, but is still aesthetically appealing from the outside of the building. FIG. 2 shows ultraviolet rays coming into a building through the window 16, and being reflected by the present invention. As would be apparent to those skilled in the art, the present invention may be employed in any other opening where the user would like to limit the amount of solar irradiation received into the building. The inner layer 12, in one preferred embodiment, lining is a water-repellent polyester blend (70% polyester and 30% cotton). Although polyester is not a natural fabric, it is “inherently” flame resistant. Flame-retardants are chemically inserted during the manufacturing process and become part of the molecular composition of the fabric. The resulting polymer is very stable and there is little likelihood that chemicals can be released from the material, as could be the case when the finished product is treated with flame-retardants. The flame retardant nature of the polyester blend fabric is advantageous to commercial consumers who are required to meet flame retardant standards for their buildings and the remodeling of buildings. Although other sheer fabrics may be used for the inner layer 12 of the present invention, the preferred embodiment is a sheer fabric that is either green or flame resistant, and water repellent. Because windows frequently collect condensation, a water repellent sheer fabric is preferred so that the window covering of the present invention does not collect water, which can lead to bacterial or fungal growth.

In one preferred embodiment of the present invention, the outer layer 10 of the present invention has an opening 13 to allow the insertion of an installation rod 14, as depicted in FIGS. 1-3. The installation rod 14 may be a built-in tension rod, which can be seamlessly designed into the opening 13 of the outer layer 10 and is housed in a hollow protective barrier. The installation rod 14 may contain pressured springs inside the rod and allows for easy self-mounting and installation into the window frame (FIG. 2). The installation rod 14 may have rubber tipped ends 15 to hold the present invention in place without the use of additional hardware or holes drilled into walls, doors, and the like. The protective barrier of the tension rod has a hollow shape and is designed to house and support the built-in spring tension rod while allowing the window covering to be stored and packaged in a convenient manner. The width of present invention is taken into consideration to prevent sagging and inadequate support of the mounted drapery fabric panel. Other methods for hanging the present invention are known to those skilled in the art and do not depart from the scope of the invention.

The three layers of the present invention may be connected in a variety of ecologically conscious means. The three layers are not connected via toxic or synthetic adhesives. In the preferred embodiment, the outer 10, middle 11, and inner 12 layer of the present invention are connected by mechanical means such as sewing with green fibers. Alternative methods of connection that are ecologically conscious such as radio frequency (RF), ultrasonic or spot welding may be employed in the present invention. It is contemplated that green adhesives that do not interfere with the properties of the layers of the present invention can be used.

The description contained herein is for purposes of illustration and not for purposes of limitation. Changes and modifications may be made to the embodiments of the description and still be within the scope of the invention. Furthermore, obvious changes, modifications, or variations will occur to those skilled in the art. Also, all references cited above are incorporated herein by reference, in their entirety, for background and to assist the reader of this disclosure.

While the invention has been shown and described herein with reference to particular embodiments, it is to be understood that the various additions, substitutions, or modifications of form, structure, arrangement, proportions, materials, and components and otherwise, used in the practice and which are particularly adapted to specific environments and operative requirements, may be made to the described embodiments without departing from the spirit of the present invention. Accordingly, it should be understood that the embodiments disclosed herein are merely illustrative of the principles of the invention. Various other modifications may be made by those skilled in the art which will embody the principles of the invention and fall within the spirit and scope thereof.

I claim:

1. A window covering for energy conservation comprising:
an outer layer comprising a green fabric that is aesthetically pleasing and non corrosive to a middle layer;
said middle layer comprising a polymer that has been metalized; and
an inner layer comprising a sheer fabric and allows light to enter therethrough to said middle layer, and said sheer fabric being water repellant and flame retardant;
wherein said outer layer, middle layer, and inner layer are connected by nonsynthetic and nontoxic means.

2. The window covering for energy conservation of claim 1, wherein the green fabric is comprised of hemp and cotton fibers.

3. The window covering for energy conservation of claim 1, wherein the green fabric is, either singularly or in combination, wool, hemp, jute, bamboo, alpaca, silk, or organic cotton.

4. The window covering for energy conservation of claim 1, wherein the polymer is polyethylene.

5. The window covering for energy conservation of claim 1, wherein the metal is aluminum.

6. The window covering for energy conservation of claim 1, wherein the sheer fabric is comprised of polyester and cotton fibers.

7. The window covering for energy conservation of claim 1, wherein the connection between the outer layer, the middle layer, and the inner layer is by sewing, radiofrequency welding, spot welding, ultrasonic welding, or nontoxic adhesives.

8. A window covering for energy consumption comprising:
an outer layer comprising a fabric comprised of hemp and cotton fibers;
a middle layer comprising a polyethylene film that is metalized; and
an inner layer comprising a sheer fabric comprised of polyester and cotton fibers;
wherein said outer layer, middle layer, and inner layer are connected by means of sewing with green fibers.

9. The window covering for energy conservation of claim 8, wherein said outer layer, middle layer, and inner layer provide insulation, has fire retardant properties, and prohibits the transmission of approximately 99 percent of ultraviolet light.

10. The window covering for energy conservation of claim 8, wherein said outer layer is comprised of approximately 55% hemp fibers and approximately 45% cotton fibers.

11. The window covering for energy conservation of claim 8, wherein said outer layer is aesthetically pleasing to the consumer.

12. The window covering for energy conservation of claim 8, where in said middle layer is comprised of approximately between ½ mil to 1 mil, or approximately between 0.0005 of an inch to 0.001 of an inch, metalized polyethylene film with 2.0 to 2.2 optical density.

13. The window covering for energy conservation of claim 8, wherein said inner layer is comprised of approximately 70% polyester and approximately 30% cotton.

14. A window covering for energy conservation comprising:
an outer layer comprising a green fabric comprised of approximately 55% hemp fibers and approximately 45% cotton;
a middle layer comprising a metalized film comprised of approximately between ½ mil to 1 mil, or approximately between 0.0005 of an inch to 0.001 of an inch, metalized polyethylene film with 2.0 to 2.2 optical density; and
an inner layer comprising a sheer fabric comprised of approximately 70% polyester and approximately 30% cotton;
wherein said outer layer, middle layer, and inner layer are connected by means of sewing with green fibers.

15. The window covering for energy conservation of claim 14, wherein said outer layer, middle layer, and inner layer provide insulation, has fire retardant properties, and prohibits the transmission of approximately 99 percent of ultraviolet light.

16. The window covering for energy conservation of claim 14, wherein said outer layer is aesthetically pleasing to the consumer.
